(19) United States
(12) Patent Application Publication
(10) Pub. No.: US 2020/0175459 A1
(43) Pub. Date: Jun. 4, 2020

(54) A SYSTEM AND METHOD FOR MANAGEMENT OF A TASK

(71) Applicant: SALES CANDY INTERNATIONAL SDN BHD, Kuala Lumpur (MY)

(72) Inventors: Chen Huah CHEE, Kuala Lumpur (MY); Jeffry Chee Hoe CHAN, Kuala Lumpur (MY)

(21) Appl. No.: 16/622,052

(22) PCT Filed: Jun. 12, 2018
(86) PCT No.: PCT/MY2018/050040

§ 371 Date: Dec. 12, 2019

(30) Foreign Application Priority Data
Jun. 13, 2017 (MY) PI 2017702173

(51) Int. Cl. G06Q 10/06; G06Q 10/10; G06Q 30/00; G06F 16/215; H04M 3/42

(52) U.S. Cl. CPC G06Q 10/063114; G06Q 10/06393; G06Q 10/06398; G06Q 50/01; G06Q 30/0185; G06F 16/215; H04M 3/42034; G06Q 10/10

(57) ABSTRACT

The present invention to a system and a method for management of a task, more particularly the present invention relates to a system and a method for receiving, processing, distributing, monitoring and managing the task, wherein the system comprising a receiver module, processing module, a storage module, a communication module, a distribution module, a managing module, and a monitoring module.

### TECHNICAL FIELD

The present invention relates to a system and a method for management of a task, more particularly the present invention relates to a system and a method for receiving, processing, distributing, monitoring and managing the task.

### BACKGROUND OF INVENTION

In the workforce of modern times, there are a plenty of jobs that provide services to clients or customers, and services for acquisition of products. Relevant companies often hire workers to provide services to the clients or customers. However, in these systems, there is a lack of ability to track what a worker does with the tasks assigned to the worker.

The systems, such as the client relationship management systems, rely solely on the workers to honestly update a task status. More often than not, it is difficult to monitor and manage the workers in environments that require workers to work outdoors, as there is lack of monitoring capabilities. This is very crucial in the world today as timing is important for the worker to attend and close a deal in a prompt manner. If the task is left unattended, the customers may lose interest in a particular service or products.

As an example, in the process of purchasing a property, the process begins with a potential customer who is interested in purchasing a particular property, would enquire more information on the property. The inquiry can be in the form of an e-mail inquiry, online advertisements, social media advertisements, or onsite marketing roadshows. These inquiries are categorized as potential leads. Once the information about the potential customer and type of inquiry is received, it is then the company's responsibility to attend to the lead. In conventional systems, the information on the leads is processed manually and it takes 2 to 3 days later for a manager to assign the leads to a worker. By this time, the lead might turn “cold” and the potential customer may lose interest to purchase the property, and as a result the company loses a business opportunity.

There are prior art that disclose solutions to overcome the aforementioned problems. US 2010/0257012 A1 discloses systems for managing and tracking customer service orders, more particularly, the prior art relates to the collection, execution, tracking, updating, and management of leads. However, the system and method of the prior art manually assigns a lead to a contractor based on the resources and expertise level of the contractor.

WO 00/072210 A1 discloses a system for processing customer leads, and managing routing of the leads such that a salesperson would attend to the leads. U.S. Pat. No. 8,271,355 B2 discloses a sales force automation system and, more particularly, to an automated sales system which facilitates the sale of an item or service by intelligently integrating into a single system tools used by a salesperson in the process.

However, the prior art above do not address a solution for promptly and effectively attending to a lead in the form of a task.

There is therefore a need for a system and method for management of a task, in that the tasks are effectively received and processed, and each task is distributed and monitored whether the task is promptly attended.

### SUMMARY OF INVENTION

The present invention aims to provide a system and method for managing a task, such that each task received by the system is routed to and attended by a first user, or the task is rerouted to another available user in the event the task is unattended by the first user.

It is an object for the present invention to provide a system for management of a task comprising a receiver module for receiving information of at least a task, a processing module for processing information of said at least a task from said receiver module, a storage module for storing information of said at least a task from said processing module and continuously updating information of said at least a task, a communication module for receiving information of said at least a task from said storage module and routing said at least a task to a first user, a distribution module for distributing information of said at least a task from said storage module to a first user, a managing module for managing said at least a task, and a monitoring module for monitoring status of said at least a task.

It is another object of the present invention to provide a system for management of a task comprising a logic module that is configured for analyzing and determining a first user for handling said at least a task, and the logic module configured for analyzing and determining another user in the event said at least a task is unaccepted by said first user.

It is yet another object of the present invention to provide a method for management of a task comprising the steps of receiving information of at least a task by a receiver module, processing information of said at least a task processing module, routing said information to said at least a first user by a communication module, providing options to said first user for handling said at least a task, assigning said at least a task to said first user by a distribution module, rerouting said at least a task to an available user by a communication module in the event said first user is unable to attend to said at least a task.

The system and method of the present invention provide a solution for effectively receiving and processing tasks, distributing the tasks, and monitoring each task whether the task is promptly attended.

### BRIEF DESCRIPTION OF DRAWINGS

FIG. 1 illustrates a schematic representation of the system according to the preferred embodiment of the present invention.

FIG. 2 illustrates a schematic representation of the system according to the preferred embodiment of the present invention.

FIG. 3 illustrates a flowchart of method according to the preferred embodiment of the present invention.

### DETAILED DESCRIPTION OF EMBODIMENTS

Described below are preferred embodiments of the present invention with reference to the accompanying drawings. Each of the following preferred embodiments describes an example not limiting in any aspect.

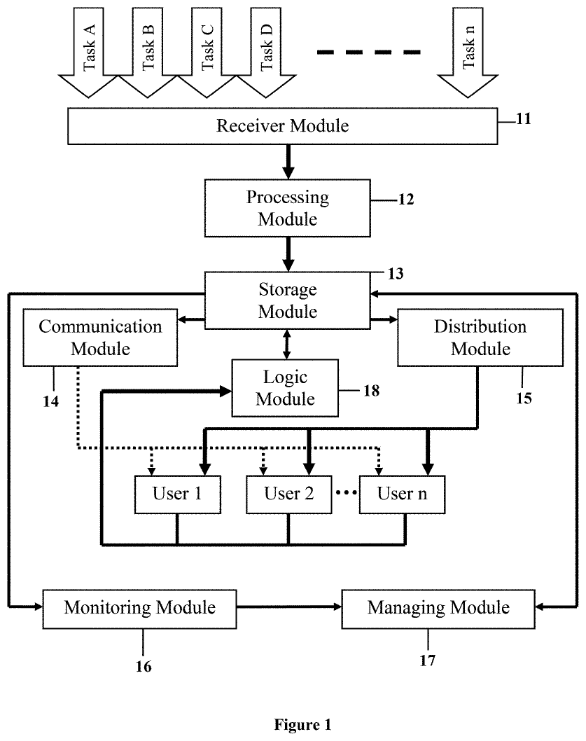

Referring to FIG. 1, there is illustrated a schematic representation of the system architecture according to the present invention comprising a receiver module (11) for receiving information of at least a task, processing module (12) for processing information of said at least a task from said receiver module (11), a storage module (13) for storing information of said at least a task from said processing module (12) and continuously updating information of said at least a task, a communication module (14) for receiving information of said at least a task from said storage module (13) and routing said at least a task to a first user, a distribution module (15) for receiving and distributing information of said at least a task from said storage module (13) to said first user, a managing module (16) for managing said at least a task, and a monitoring module (17) for monitoring status of said at least a task, and the preferred embodiment of the present invention further comprises a logic module (18) that is configured for analyzing and determining said first user for handling said at least a task, and the logic module configured for analyzing and determining another user in the event said at least a task is unaccepted by said first user.

Said receiver module (11) of the present invention is for receiving information of at least a task. It is shown in FIG. 1 that said receiver module (11) is configured for receiving a plurality of tasks, and each task is identified as Task A, Task B, Task C, Task D and until Task n. In the preferred embodiment of the present invention, the tasks are preferably but not limited to leads that are generated from inquiries of a particular service or product.

Said tasks preferably originate from a proprietary conversion form. The conversion form is embedded in a webpage that is accessed by a potential client or a potential customer. The conversion form is provided to read a tracking setting which is tagged in the uniform resource locator (URL) of the webpage and the tracking information is passed as hidden fields to a server of the preferred embodiment of the present invention. The tracking setting is preferably but not limited to Urchin Tracking Module (UTM) and comprises UTM source, UTM medium, UTM campaign, UTM term and UTM content.

UTM source is preferably used to identify the sources of the tasks, such as from the advertisements, social media, and product websites. UTM medium is preferably used to categorize the sources. UTM campaign is preferably used to identify promotions or specific marketing offers. UTM term is preferably used to identify specific terms that are searched via a search engine. UTM content is preferably used to identify a unique feature of a property, such as location of a property or type of the property.

Said processing module (12) of the present invention is for processing information of said at least a task from said receiver module (11). Also, said processing module (12) is configured for identifying and removing duplicate information, and said processing module (12) is responsive to the information of the plurality of the tasks, and while capable of reducing spams and recognizing telephone numbers, said processing module (12) further processes the information of said at least a task from said receiver module (11).

Said processing module (12) of the present invention is also configured for analyzing media information such as image, video, speech, or text from information that is fetched and collected from social media sites of a potential customer, or other profiling of the potential customer, so that a user or a worker would be able to know interests or profiling of the customer and focus on a pitch which would interest the potential customer. The profile information of the potential customer is preferably but not limited to a picture, video, audio, texts posted by the potential customer, education background, age, gender, job position, potential income level, and the profile information is tagged to a photo for selection.

Said processing module (12) of the present invention is further configured for dynamically generating contents of a landing page based on the profiling of the task for split testing purposes. The dynamic landing page would display the page either in a variety of design, layout of information, priority of information, or hiding some information according to the parameter passed on in the URL parameter. This configuration would dynamically generate the content of the landing page which is more relevant to the potential customer.

Said storage module (13) of the present invention is for storing information of said at least a task from said processing module (12) and continuously updating information of said at least a task. New tasks will be continuously logged in the storage module (12), and new name of the task and new contact information such as email will be updated in the task record and will also be logged.

Said communication module (14) of the present invention is for receiving information of said at least a task from said storage module (13) and routing said at least a task to a first user. It is shown in FIG. 1 that said communication module (14) routes said at least a task to a plurality of users, and each user is identified as User 1, User 2 and until User n.

The routing is based on a daily assigned number of tasks to said first user and is routed randomly on a round-robin sequence. Said tasks will be re-assigned to the same first user, as long as the first user is still active and is in a same project, else it will be assigned to other users in the project. If there is a same task for a new project, the task will be treated as a new task, and will be assigned to the same first user if the user is in the same project as well, else it will be assigned to other users.

In another preferred embodiment of the present invention, the routing is based on an analysis of the tasks, said first user, and said potential customer. The analysis is to match a new task with a highest conversion rate of said first user based on a historical data of said first user, and also the interests and profiling of the potential customer. The analysis is preferably performed by big data analysis. The routing in this regard facilitates effectiveness of the routing such that the task is routed to said first user who would be more suitable to handle the task according to the interests and profiling of the potential.

Said communication module (14) of the present invention is also configured for providing handling options to said first user. Said handling options comprise a selection of either accepting or declining said at least a task. Also, said communication module (14) is configured for rerouting said at least a task to another user if said task is declined by said first user or said task is unattended for predetermined period of time, preferably 45 seconds.

The input of said first user, whether accepting, declining or ignoring said at least task, the input is received by said logic module, and said logic module (18) analyzes and determines another user in the event said at least a task is unaccepted or unattended by said first user.

Said logic module (18) also receives information of said at least a task from said storage module (13) for analyzing actions taken by said first user, whether said first user has made a telephone call, has sent messages in the form of a SMS (short message service) or instant message, has attended to a potential customer via walk-in registrations, or has updated status of said at least a task. The analyzed information will be then updated in said storage module (13), thus every action taken by said first user will be analyzed and recorded in said storage module (13) for monitoring and management by a second user.

In another embodiment, said communication module (14) of the present invention is also configured for routing said task to all users, and said task can be attended on a first come first serve basis, or routed to a top performer, or routed in a predetermined sequence.

Said communication module (14) is further configured for routing said at least a task by a preferred time, and said communication module (14) is configured for routing said at least a task by a preferred language. These features would allow the potential customer to select a preferred language or preferred day or time for a follow up call. Said communication module (14) also provides routing of said at least a task to a specific said first user, and routing of said at least a task in a geographical area of said at least a task is initiated.

Said distribution module (15) of the present invention is for receiving and distributing information of said at least a task from said storage module (13) to a first user. This action is executed in the event said first accepts said task.

Said managing module (16) of the present invention is for managing said at least a task, and is configured for managing said at least a task by a second user. Said second user is preferably a manager who is in charge of a specific project, and super manager who has access to all projects. Manager is a user type with access to one or more projects.

Said managing module (16) is configured for managing said at least a task by key performance index. Also, said managing module (12) allows the second user to manage various attributes of the system such as preferably but not limited to project group management, task management, action status management, lead source settings, worker management, project settings, account settings, reporting, customized won screen, alert notification, notification center, and web user experience.

Also, the system in the preferred embodiment of the present invention is configured with an alert feature for alerting a second user whether said first user has attended to said at least a task. This feature assists the manager to be aware of any attended task by said first user.

Further, the system is preferably configured for independently detecting errors in the actions taken by said first user, detecting whether said first user has attended to the task accepted by said first user, or detecting the follow up date set by said first user is inappropriate. In the event the system detects unusual operation by said first user, the system is configured for providing alert notification to said second user.

Also, the system is configured in the parameter settings to prevent said first user from misusing or exploiting the system, such that the system monitors the behavior of said first user via the input of said first user. The system detects for abnormalities and reports the abnormalities to said second user. The abnormalities are such as whether said at least a task is left unattended for predetermined period of time in view of unusual online rate of said first user and acceptance of said first user, whether any action is taken after said first user has accepted a task, whether a follow up is not taken within a predetermined period of time, whether said at least a task is left unassigned for predetermined period of time, whether the system has missed receiving said at least a task, or whether the number of tasks that are attended satisfies a predetermined quota.

Said monitoring module (17) of the present invention is for monitoring of said at least a task, and is configured for managing said at least a task by a third user. Said third user is preferably an administrator who oversees and monitors all projects.

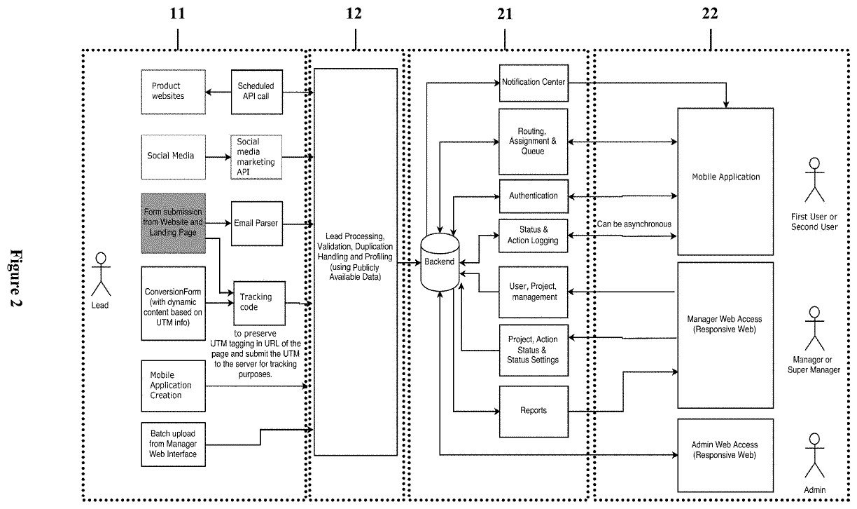

Referring to FIG. 2, there is illustrated a schematic representation of the system architecture according to the present invention comprising a receiving module (11), a processing module (12), a post processing module (21), and end user applications (22).

Said receiver module (11) of the present invention is for receiving information of at least a task, and as shown in FIG. 1 that said receiver module (11) is configured for receiving a plurality of tasks, and each task is identified as Task A, Task B, Task C, Task D and until Task n. In the preferred embodiment of the present invention, the tasks are preferably but not limited to leads that are generated from inquiries of a particular service or product.

Said tasks preferably originate from a proprietary conversion form. The conversion form is embedded in a webpage that is accessed by a potential client or a potential customer. The conversion form is provided to read a tracking setting which is tagged in the uniform resource locator (URL) of the webpage and the tracking information is passed as hidden fields to a server of the preferred embodiment of the present invention. The tracking setting is preferably but not limited to Urchin Tracking Module (UTM) and preferably comprises UTM source, UTM medium, UTM campaign, UTM term and UTM content.

UTM source is preferably used to identify the sources of the tasks, such as from the advertisements, social media, and product websites. UTM medium is preferably used to categorize the sources. UTM campaign is preferably used to identify promotions or specific marketing offers. UTM term is preferably used to identify specific terms that are searched via a search engine. UTM content is preferably used to identify a unique feature of a property, such as location of a property or type of the property.

Said processing module (12) of the present invention is for processing information of said at least a task from said receiver module (11). Also, said processing module (12) is configured for identifying and removing duplicate information, and said processing module (12) is responsive to the information of the plurality of the tasks, and while capable of reducing spams and recognizing telephone numbers, said processing module (12) further processes the information of said at least a task from said receiver module (11).

Said processing module (12) of the present invention also configured for analyzing media information such as image, video, speech, or text from information that is fetched and collected from social media sites of a potential customer, or other profiling of the potential customer, so that a user or a worker would be able to know interests or profiling of the customer and focus on a pitch which would interest the potential customer. The profile information of the potential customer is preferably a picture, video, audio, texts posted by the potential customer, education background, age, gender, job position, potential income level, and the profile information is tagged to a photo for selection.

Said processing module (12) of the present invention is further configured for dynamically generating contents of a landing page based on the profiling of the task for split testing purposes. The dynamic landing page would display the page either in a variety of design, layout of information, priority of information, or hiding some information according to the parameter passed on in the URL parameter. This configuration would dynamically generate the content of the landing page which is more relevant to the potential customer.

The processing module (12) for processing information of said at least a task from said receiver module (11). Said processing module (12) is configured for identifying and removing duplicate information.

The post processing module (21) is a combination of a storage module (13), a communication module (14), a distribution module (15), a managing module (16), and a monitoring module (17) as shown in FIG. 1 and as described in the foregoing description.

Said end user applications (22) are applications residing in a computing device or handheld devices of a first user, second user and a third user. Said first user is preferably a worker, said second is a preferably a manager or a super manager, and said third user is preferably an administrator of the entire system of the present invention.

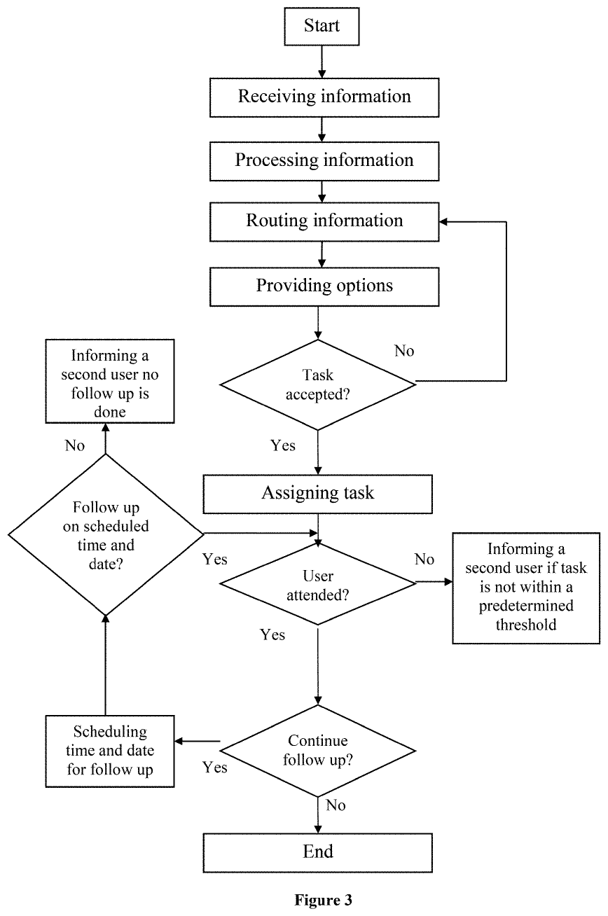

Referring to FIG. 3, there is illustrated flowchart of method according to the preferred embodiment of the present invention.

The preferred method of the present invention comprising the steps of initially receiving information of at least a task by a receiver module (11), processing information of said at least a task processing module (12), routing said information to said at least a first user by a communication module (14), providing options to said first user for handling said at least a task, assigning said at least a task to said first user by a distribution module (15), rerouting said at least a task to an available user by a communication module (14) in the event said first user is unable to attend to said at least a task.

If said first user has attended to the task, the process continues whether to follow up with the potential customer, and if no follow up is required, the task is either completed or dropped. If said user has not attended to the task, the preferred method of the present invention will notify a second user that the task is unattended. In the process for follow up, if a follow up is required, a time and date will be scheduled for the follow up action, and the process checks whether the follow up is performed on scheduled time and date. If the follow up is not performed on scheduled time and date, the process will notify said second user that no follow up was done. If the follow up is performed on scheduled time and date, the method continues to check whether said first user has attended to the task.

Said receiver module (11) of the present invention is for receiving information of at least a task. In the preferred embodiment of the present invention, said tasks are preferably but not limited to leads that are generated from inquiries of a particular service or product.

Said processing module (12) of the present invention is for processing information of said at least a task from said receiver module (11). Also, said processing module (12) is configured for identifying and removing duplicate information, and said processing module (12) is responsive to the information of the plurality of the tasks, and while capable of reducing spams and recognizing telephone numbers, said processing module (12) further processes the information of said at least a task from said receiver module (11).

Said processing module (12) of the present invention also configured for analyzing media information such as image, video, speech, or text from information that is fetched and collected from social media sites of a potential customer, or other profiling of the potential customer, so that a user or a worker would be able to know interests or profiling of the customer and focus on a pitch which would interest the potential customer. The profile information of the potential customer is preferably a picture, video, audio, texts posted by the potential customer, education background, age, gender, job position, potential income level, and the profile information is tagged to a photo for selection.

Said processing module (12) of the present invention is further configured for dynamically generating contents of a landing page based on the profiling of the task for split testing purposes. The dynamic landing page would display the page either in a different design, layout of information, priority of information, or hiding some information according to the parameter passed on in the URL parameter. This configuration would dynamically generate the content of the landing page which is more relevant to the potential customer.

Said storage module (13) of the present invention is for storing information of said at least a task from said processing module (12) and continuously updating information of said at least a task. New tasks will be continuously logged in the storage module (12), and new name of the task and new email will update the task record and will also be logged.

Said communication module (14) of the present invention is for receiving information of said at least a task from said storage module (13) and routing said at least a task to a first user. It is shown in FIG. 1 that said communication module (14) routes said at least a task to a plurality of users, and each user is identified as User 1, User 2 and until User n.

The routing is based on a daily assigned number of tasks to said first user and is routed randomly on a round-robin sequence. Said tasks will be re-assigned to the same first user, as long as the first user is still active and is in a same project, else it will be assigned to other users in the project. If there is a same task for a new project, the task will be treated as a new task, and will be assigned to the same first user if the user is in the same project as well, else it will be assigned to other users.

In another preferred embodiment of the present invention, the routing is based on an analysis of the tasks, said first user, and said potential customer. The analysis is to match a new task with a highest conversion rate of said first user based on a historical data of said first user, and also the interests and profiling of the potential customer. The analysis is preferably performed by big data analysis. The routing in this regard facilitates effectiveness of the routing such that the task is routed to said first user who would be more suitable to handle the task according to the interests and profiling of the potential.

Said communication module (14) of the present invention is also configured for providing handling options to said first user. Said handling options comprise a selection of either accepting or declining said at least a task. Also, said communication module (14) is configured for rerouting said at least a task to another user if said task is declined by said first user or said task is unattended for predetermined period of time, preferably 45 seconds.

The input of said first user, whether accepting, declining or ignoring said at least task, the input is received by said logic module, and said logic module (18) analyzes and determines another user in the event said at least a task is unaccepted or unattended by said first user.

Said logic module (18) also receives information of said at least a task from said storage module (13) for analyzing actions taken by said first user, whether said first user has made a telephone call, has sent messages in the form of a SMS (short message service) or instant message, has attended to a potential customer via walk-in registrations, or has updated status of said at least a task. The analyzed information will be then updated in said storage module (13), thus every action taken by said first user will be analyzed and recorded in said storage module (13) for monitoring and management by a second user.

In another embodiment, said communication module (14) of the present invention is also configured for routing said task to all users, and said task can be attended on a first come first serve basis, or routed to a top performer, or routed in a predetermined sequence.

Said communication module (14) is further configured for routing said at least a task by a preferred time, and said communication module (14) is configured for routing said at least a task by a preferred language. These features would allow the potential customer to select a preferred language or preferred day or time for a follow up call. Said communication module (14) also provides routing of said at least a task to a specific said first user, and routing of said at least a task in a geographical area of said at least a task is initiated.

Said distribution module (15) of the present invention is for receiving and distributing information of said at least a task from said storage module (13) to a first user. This action is executed in the event said first accepts said task.

In as much as the present invention is subject to many variations, modifications and changes in detail, it is intended that all matter contained in the foregoing description or shown in the accompanying drawings shall be interpreted as illustrative and not in a limiting sense.

1. (canceled)

2. A system for management of a task to attend to a lead comprising:
a receiver module for receiving information of at least a task;
a processing module for processing information of said at least a task from said receiver module;
a storage module for storing information of said at least a task from said processing module and continuously updating information of said at least a task;
a communication module for receiving information of said at least a task from said storage module and routing said at least a task to a first user via a device;
a distribution module for receiving and distributing information of said at least a task from said storage module to said first user;
a managing module for managing said at least a task;
a monitoring module for monitoring status of said at least a task;
a logic module configured for analyzing and determining said first user for handling said at least a task, and configured for analyzing and determining another user in the event said at least a task is unaccepted by said first user;
wherein the logic module is further configured for analyzing actions taken by said first user on the device and recording analyzed information in said storage module.

3. The system according to claim 2, wherein said processing module is configured for identifying and removing duplicate information.

4. The system according to claim 2, wherein said processing module is configured for analyzing media information.

5. The system according to claim 2, wherein said processing module is configured for generating contents of a landing page.

6. The system according to claim 2, wherein said communication module is configured for providing handling options to said first user.

7. The system according to claim 6, wherein said handling options comprise a selection of either accepting or declining said at least a task.

8. The system according to claim 2, wherein said communication module is configured for rerouting said at least a task to another user.

9. (canceled)

10. (canceled)

11. The system according to claim 2, wherein said actions taken by said first user comprise, whether said first user has made a call, has sent messages in the form of a short message service or instant message.

12. The system according to claim 2, wherein said communication module is configured for routing said at least a task by a preferred time.

13. The system according to claim 2, wherein said communication module is configured for routing said at least a task by a preferred language.

14. The system according to claim 2, wherein said communication module is configured for routing said at least a task to a specific said first user.

15. The system according to claim 14, wherein said communication module is configured for routing said at least a task in a geographical area of said at least a task is initiated.

16. The system according to claim 2, wherein said system is configured for recognizing telephone number of a potential customer.

17. The system according to claim 2, wherein said managing module is configured for managing said at least a task by a second user.

18. The system according to claim 2, wherein said managing module is configured for managing said at least a task by key performance index.

19. The system according to claim 2, wherein said system is configured for alerting a second user whether said first user has attended to said at least a task.

20. The system according to claim 19, wherein said system is configured for notifying said second user in the event the system detects an error in at least an action of said first user.

21. The system according to claim 19, wherein said system is configured for notifying said second user in the event the system detects said first user is misusing said system.

22. The system according to claim 2, wherein said monitoring module is configured for monitoring status of said at least a task by a third user.

23. A method for management of a task to attend to a lead comprising the steps of:
receiving information of at least a task by a receiver module;
processing information of said at least a task processing module;
routing said information to said at least a first user via a device and providing options to said first user for handling said at least a task, by a communication module;
assigning said at least a task to said first user by a distribution module;
rerouting said at least a task to an available user by a communication module in the event said first user is unable to attend to said at least a task;
analyzing actions taken by said first user on the device and recording analyzed information in said storage module.

24. The method according to claim 23, wherein said processing module is configured for identifying and removing duplicate information.

25. The method according to claim 23, wherein the method further comprises a step of analyzing media information.

26. The method according to claim 23, wherein the method further comprises a step of generating contents of a landing page.

27. The method according to claim 23, wherein said handling options comprise a selection of either accepting or declining said at least a task.

28. The method according to claim 23, wherein said communication module is configured for routing said at least a task by a preferred time.

29. The method according to claim 23, wherein said communication module is configured for routing said at least a task by a preferred language.

30. The method according to claim 23, wherein said communication module is configured for routing said at least a task to a specific said first user.

31. The method according to claim 30, wherein said communication module is configured for routing said at least a task in a geographical area of said at least a task is initiated.
